(19) United States
(12) Patent Application Publication
(10) Pub. No.: US 2017/0045130 A1
(43) Pub. Date: Feb. 16, 2017

(54) SHAFT JOURNALS WITH EXOTHERMICALLY BONDED SLEEVES

(71) Applicant: Caterpillar Inc., Peoria, IL (US)

(72) Inventor: Daniel Thomas Cavanaugh, Chillicothe, IL (US)

(73) Assignee: Caterpillar Inc., Peoria, IL (US)

(21) Appl. No.: 14/825,797

(22) Filed: Aug. 13, 2015

(51) Int. Cl. F16H 53/02; B23K 20/16

(52) U.S. Cl. CPC F16H 53/025; B23K 20/165

(57) ABSTRACT

A contact feature of a shaft for a machine is disclosed herein. In embodiments, the contact feature includes an integral portion, a sleeve, and a bond layer. The integral portion is integral to the shaft and includes a profile that is less than the overall profile of the contact feature. The sleeve is located around the integral portion and includes the overall profile of the contact feature. The bond layer is located between the integral portion and the sleeve. The bond layer joins at least a majority of an interface between the integral portion and the sleeve together.

### TECHNICAL FIELD

The present disclosure generally pertains to rotating shafts for machines, and is directed toward a rotating shaft including a journal with an exothermically bonded sleeve.

### BACKGROUND

Rotating shafts, such as camshafts and crankshafts, for machines, such as construction and mining machines, generally include various contact features, such as journals and cams that are in constant contact with other components of the machines causing wear at the surface of the contact feature. Building contact features back up is costly and time consuming.

U.S. Pat. No. 5,536,587 to W. Whitney discloses a shaft bearing formed from an aluminum alloy. The alloy may be formed into a continuous solid strip by a quench casting operation, wherein molten alloy is fed into an interface between two internally-cooled rolls to freeze the alloy into a solid strip condition in less than one second. The aluminum alloy strip can be pressure bonded to a steel backing strip to form a composite strip useful in forming a shaft bearing.

The present disclosure is directed toward overcoming one or more of the problems discovered by the inventor.

### SUMMARY OF THE DISCLOSURE

A contact feature of a shaft for a machine is disclosed herein. In embodiments, the contact feature includes an integral portion, a sleeve, and a bond layer. The integral portion is integral to the shaft and includes a profile that is less than the overall profile of the contact feature. The sleeve is placed around the integral portion and includes the overall profile of the contact feature. The bond layer is placed between the integral portion and the sleeve. The bond layer joins at least a majority of an interface between the integral portion and the sleeve together.

A method for manufacturing a shaft for a machine is also disclosed. In embodiments, the method includes placing a sleeve around an integral portion of the shaft. The method also includes placing a reaction material between the sleeve and the integral portion. The method further includes bonding at least a majority of an interface between the integral portion and the sleeve together with the reaction material to form a contact feature of the shaft that includes the sleeve, the integral portion and a resultant bond layer there between.

### BRIEF DESCRIPTION OF THE DRAWINGS

FIG. 1 is a perspective view of a camshaft.

FIG. 2 is a cross-sectional view of the camshaft of FIG. 1 taken along the line II-II through an end journal.

FIG. 3 is a cross-sectional view of the camshaft of FIG. 1 taken along the line III-III through an inner journal.

FIG. 4 is a cross-sectional view of the camshaft of FIG. 1 taken along the line IV-IV through a cam.

FIG. 5 is a perspective view of a crankshaft.

FIG. 6 is a cross-sectional view of the crankshaft of FIG. 5 taken along the line VI-VI through a main journal.

FIG. 7 is a cross-sectional view of the portion of FIG. 6 encircled in the dashed line labeled VII.

FIG. 8 is a flowchart of a method for manufacturing a rotating shaft including a contact feature for a machine.

### DETAILED DESCRIPTION

The systems and methods disclosed herein include a shaft, such as a camshaft or a crankshaft, for a machine, such as a construction or a mining machine. In embodiments, the shaft includes contact features, such as journals and cams that include an integral portion and a sleeve. The integral portion is integral to a majority of the shaft, while the sleeve is bonded to the integral portion by an exothermic reaction. Bonding the sleeve to the integral portion may prevent rotation of the sleeve relative to the integral portion.

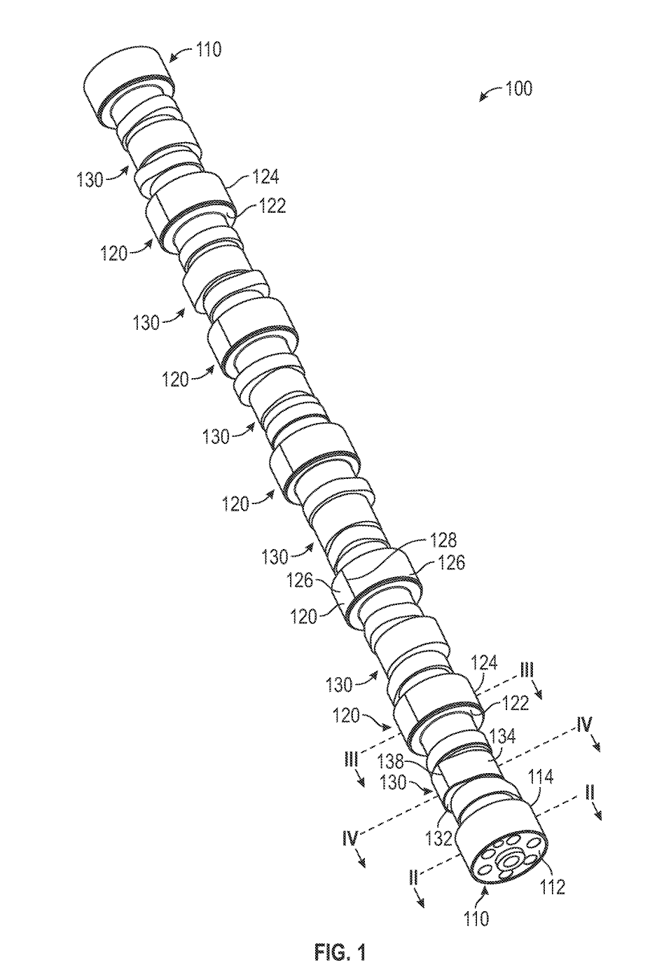

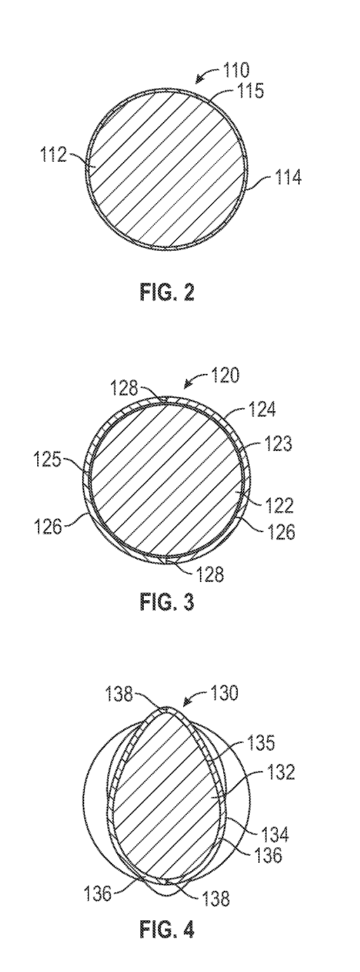

FIG. 1 is a perspective view of a camshaft 100. Some of the features illustrated in this figure and in other figures may be exaggerated for clarity and ease of explanation. The camshaft 100 includes a shaft portion 105 and various contact features including end journals 110, inner journals 120, and cams 130. The camshaft 100 may include an end journal 110 at each end of the camshaft 100. End journals 110 support the ends of the camshaft 100 in the engine block and may ride on replaceable bearings. FIG. 2 is a cross-sectional view of the camshaft 100 of FIG. 1 taken along the line II-II through an end journal 110.

One or more of the end journals 110 may include an end journal integral portion 112, an end journal sleeve 114, and an end journal bond layer 115. The end journal integral portion 112 is integral to a majority of the camshaft 100, such as the shaft portion 105. The end journal integral portion 112 may include a cylindrical shape. The profile, such as the outer diameter, of the end journal integral portion 112 is smaller than the overall profile, such as the outer diameter, of the end journal 110. The profile of the journal integral portion 112 prior to being bonded to the end journal sleeve 114 may be offset from the overall profile of the end journal 110 by a predetermined amount, such as the thickness of the end journal sleeve 114.

End journal sleeve 114 is located outward from and surrounds the end journal integral portion 112. The end journal sleeve 114 may include a hollow cylinder shape. In the embodiment illustrated, the end journal sleeve 114 is a single integral piece formed in a hollow cylinder shape. The outer profile, such as the outer diameter, of the end journal sleeve 114 is at least as large as the desired minimum material condition of the end journal 110. Prior to being bonded to the end journal integral portion 112, the inner profile, such as the inner diameter, of the end journal sleeve 114 may be within a predetermined tolerance of the profile of the end journal integral portion 112. In some embodiments, the inner profile of the end journal sleeve 114 may be smaller than the outer profile of the end journal integral portion 112 to form an interference fit between the two prior to bonding.

The end journal sleeve 114 and the end journal integral portion 112 are joined at their interface by the end journal bond layer 115. The interface may be at the inner surface of the end journal sleeve 114 and the outer surface of the end journal integral portion 112 when the end journal sleeve 114 is located around the end journal integral portion 112 prior to forming the end journal bond layer 115.

The end journal bond layer 115 may be a metallurgical bond formed by an exothermic reaction ignited between the end journal integral portion 112 and the end journal sleeve 114. The end journal bond layer 115 metallurgically bonds at least a majority of the interface between the end journal sleeve 114 and the end journal integral portion 112 together, such as joining at least a majority of the inner surface of the end journal sleeve 114 and at least a majority of the outer surface of the end journal integral portion 112 together. The end journal bond layer 115 may include materials from the integral portion, materials from the sleeve, and residual reaction materials from the exothermic reaction that forms the end journal bond layer 115.

FIG. 3 is a cross-sectional view of the camshaft 100 of FIG. 1 taken along the line III-III through an inner journal 120. Referring to FIGS. 1 and 3, inner journals 120 support the camshaft 100 between the end journals 110 in the engine block and may ride on replaceable bearings. One or more of the inner journals 120 may include an inner journal integral portion 122, an inner journal sleeve 124, and an inner journal bond layer 125. The inner journal integral portion 122 is integral to a majority of the camshaft 100, such as the shaft portion 105 and to the end journal integral portions 112. The inner journal integral portion 122 may include a cylindrical shape. The profile, such as the outer diameter, of the inner journal integral portion 122 is smaller than the overall profile, such as the outer diameter, of the inner journal 120. The profile of the inner journal integral portion 122 prior to being bonded to the inner journal sleeve 124 may be offset from the overall profile of the inner journal 120 by a predetermined amount, such as the thickness of the inner journal sleeve 124.

Inner journal sleeve 124 is located outward from and surrounds the inner journal integral portion 122. The inner journal sleeve 124 may include a hollow cylinder shape and may include multiple inner journal sleeve sections 126. In the embodiment illustrated, the inner journal sleeve 124 includes two inner journal sleeve sections 126 that are combined to form the hollow cylinder shape. The inner journal sleeve sections 126 each include two inner journal sleeve ends 128. The inner journal sleeve sections 126 may be bonded together, such as by welding or by an exothermic reaction, at their adjoining inner sleeve ends 128. In some embodiments, the bonding of the inner journal sleeve sections 126 is adjacent the outer surface of the inner journal sleeve 124 and does not penetrate to the inner journal integral portion 122. The inner journal sleeve sections 126 may be symmetrical and may be split down the center of the inner journal sleeve 124. In the embodiment illustrated, the inner sleeve ends 128 extend between the outer and inner surfaces of the inner journal sleeve 124 normal to both the outer and inner surfaces.

The outer profile, such as the outer diameter, of the inner journal sleeve 124 is at least as large as the desired minimum material condition of the inner journal 120. Prior to being bonded to the inner journal integral portion 122, the inner profile, such as the inner diameter, of the inner journal sleeve 124 may be within a predetermined tolerance of the profile of the inner journal integral portion 122.

The inner journal sleeve 124 and the inner journal integral portion 122 are joined at their interface by the inner journal bond layer 125. The interface may be at the inner surface of the inner journal sleeve 124 and the outer surface of the inner journal integral portion 122 when the inner journal sleeve 124 is located around the inner journal integral portion 122 prior to forming the inner journal bond layer 125.

The inner journal bond layer 125 may be a metallurgical bond formed by an exothermic reaction ignited between the inner journal integral portion 122 and the inner journal sleeve 124. The inner journal bond layer 125 metallurgically bonds at least a majority of the interface between the inner journal sleeve 124 and the inner journal integral portion 122 together, such as joining at least a majority of the inner surface of the inner journal sleeve 124 and at least a majority of the outer surface of the inner journal integral portion 122 together. Some residual material from the exothermic reaction may remain after the formation of the inner journal bond layer 125. In the embodiment illustrated in FIG. 3, the reaction material 123 is a residual layer between the inner journal sleeve 124 and the inner journal integral portion 122. In other embodiments, the reaction material 123 is interspersed within the inner journal bond layer 125. In embodiments, the inner journal sleeve 124 includes a layer of the reaction material 123. The reaction material 123 coats the inner surface of the inner sleeve journal 124 and may coat each inner journal sleeve section 126. The reaction material 123 may be an exothermic material, such as thermite, that provides enough heat in the reaction to metallurgically bond the inner journal integral portion 122 to the inner journal sleeve 124. The exothermic reaction system may include, inter alia, oxidation and intermetallic formation. In other embodiments, the reaction material 123 may be applied to the outer surface of the inner journal integral portion 122.

FIG. 4 is a cross-sectional view of the camshaft 100 of FIG. 1 taken along the line IV-IV through a cam 130. Referring to FIGS. 1 and 4, cams 130 generally control the timing of the opening and closing of valves in the engine of the machine. One or more of the cams 130 may include a cam integral portion 132, a cam sleeve 134, and a cam bond layer 135. The cam integral portion 132 is integral to a majority of the camshaft 100, such as the shaft portion 105, the end journal integral portions 112 and the inner journal integral portions 122. The cam integral portion 132 may include a lobe. The profile of the cam integral portion 132 is smaller than the overall profile of the cam 130. The profile of the cam integral portion 132 prior to being bonded to the cam sleeve 134 may be offset from the overall profile of the cam 130 by a predetermined amount, such as the thickness of the cam sleeve 134. The profiles of the cam integral portion 132 and of the cam 130 may be ovate and formed of a base circle with a lift profile.

Cam sleeve 134 is located outward from and surrounds the cam integral portion 132. The cam sleeve 134 may be hollow and include a constant thickness. The thickness may be within a predetermined tolerance. The cam sleeve 134 may also include multiple cam sleeve sections 136. In the embodiment illustrated, the cam sleeve 134 includes two cam sleeve sections 136 that are combined to form the full profile of the cam 130. The cam sleeve sections 136 may split the cam 130 down the centerline of the cam 130 or may split the cam 130 in other locations. The cam sleeve sections 136 each include two cam sleeve ends 138. The cam sleeve sections 136 may be bonded together, such as by welding or by an exothermic reaction, at their adjoining cam sleeve ends 138. In some embodiments, the bonding of the cam sleeve sections 136 is adjacent the outer surface of the cam sleeve 134 and does not penetrate to the cam integral portion 132. The cam sleeve sections 136 may be symmetrical and may be split down the center of the cam sleeve 134. In the embodiment illustrated, the cam sleeve ends 138 extend between the outer and inner surfaces of the cam sleeve 134 normal to both the outer and inner surfaces.

The outer profile of the cam sleeve 134 is at least as large as the desired minimum material condition of the cam 130. Prior to being bonded to the cam integral portion 132, the inner profile of the cam sleeve 134 may be within a predetermined tolerance of the outer profile of the cam integral portion 132.

The cam sleeve 134 and the cam integral portion 132 are joined at their interface by the cam bond layer 135. The interface may be at the inner surface of the cam sleeve 134 and the outer surface of the cam integral portion 132 when the cam sleeve 134 is located around the cam integral portion 132 prior to forming the cam bond layer 135.

The cam bond layer 135 may be a metallurgical bond formed by an exothermic reaction ignited between the cam integral portion 132 and the cam sleeve 134. The cam bond layer 135 metallurgically bonds at least a majority of the interface between the cam sleeve 134 and the cam integral portion 132 together, such as joining at least a majority of the inner surface of the cam sleeve 134 and at least a majority of the outer surface of the cam integral portion 132 together. Some residual material from the exothermic reaction may remain after the formation of the cam bond layer 135.

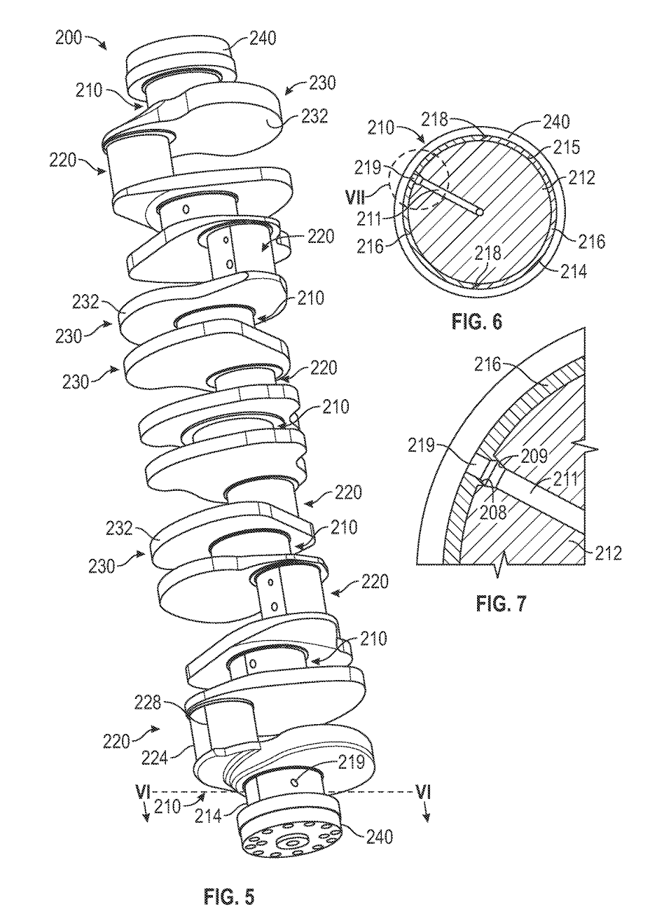

FIG. 5 is a perspective view of a crankshaft 200. The crankshaft 200 generally converts between reciprocating motion and rotational motion and may include main journals 210, rod journals 220, webs 230, and mounting flanges 240. The main journals 210 support the crankshaft 200 within the engine block and may ride on replaceable bearings. FIG. 6 is a cross-sectional view of the crankshaft 200 of FIG. 5 taken along the line VI-VI through a main journal 210. One or more of the main journals 210 may include a main journal integral portion 212, a main journal sleeve 214, and a main journal bond layer 215. The main journal integral portion 212 is integral to a majority of the crankshaft 200. The main journal integral portion 212 may include a cylindrical shape. The profile, such as the outer diameter, of the main journal integral portion 212 is smaller than the overall profile, such as the outer diameter, of the main journal 210. The profile of the main journal integral portion 212 prior to being bonded to the main journal sleeve 214 may be offset from the overall profile of the main journal 210 by a predetermined amount, such as the thickness of the main journal sleeve 214.

Main journal sleeve 214 is located outward from and surrounds the main journal integral portion 212. The main journal sleeve 214 may include a hollow cylinder shape and may include multiple main journal sleeve sections 216. In the embodiment illustrated, the main journal sleeve 214 includes two main journal sleeve sections 216 that are combined to form the hollow cylinder shape. The main journal sleeve sections 216 each include two main journal sleeve ends 218. The main journal sleeve sections 216 may be bonded together, such as by welding or by an exothermic reaction, at their adjoining inner sleeve ends 128. In some embodiments, the bonding of the main journal sleeve sections 216 is adjacent the outer surface of the main journal sleeve 214 and does not penetrate to the main journal integral portion 212. The main journal sleeve sections 216 may be symmetrical and may be split down the center of the main journal sleeve 214. In the embodiment illustrated, the main journal sleeve ends 218 extend between the outer and inner surfaces of the main journal sleeve 214 at an angle relative to a surface normal to both the outer and inner surfaces, and are not normal to the outer and inner surfaces of the main journal sleeve 214.

The outer profile, such as the outer diameter, of the main journal sleeve 214 is at least as large as the desired minimum material condition of the main journal 210. Prior to being bonded to the main journal integral portion 212, the inner profile, such as the inner diameter, of the main journal sleeve 214 may be within a predetermined tolerance of the profile of the main journal integral portion 212.

The main journal sleeve 214 and the main journal integral portion 212 are joined at their interface by the main journal bond layer 215. The interface may be at the inner surface of the main journal sleeve 214 and the outer surface of the main journal integral portion 212 when the main journal sleeve 214 is located around the main journal integral portion 212 prior to forming the main journal bond layer 215.

The main journal bond layer 215 may be a metallurgical bond formed by an exothermic reaction ignited between the main journal integral portion 212 and the main journal sleeve 214. The main journal bond layer 215 metallurgically bonds at least a majority of the interface between the main journal sleeve 214 and the main journal integral portion 212 together, such as joining at least a majority of the inner surface of the main journal sleeve 214 and at least a majority of the outer surface of the main journal integral portion 212 together. Some residual material from the exothermic reaction may remain after the formation of the main journal bond layer 215.

The main journal sleeve 214 may need to be aligned in a predetermined orientation relative to the main journal integral portion 212 to align selected features of each. FIG. 7 is a cross-sectional view of the portion of FIG. 6 encircled in the dashed line labeled VII. Referring to FIGS. 6 and 7, the main journal integral portion 212 may include an oil passage 211 and the main journal sleeve 214 may include an oil hole 219. If the oil hole 219 is not aligned with the oil passage 211, the oil passage 211 might be blocked by the main journal sleeve 214.

Referring to FIG. 7, the crankshaft 200 may include an integral portion alignment feature 209 and a sleeve alignment feature 208. The integral portion alignment feature 209 and the sleeve alignment feature 208 may be mated projections and depressions in the main journal integral portion 212 and the main journal sleeve 214. In the embodiment illustrated, the integral portion alignment feature 209 includes a chamfer located in the main journal integral portion 212 at the outer end of the oil passage 211 adjacent the main journal sleeve 214, and the sleeve alignment feature 208 includes a flange protruding inward from the main journal sleeve 214 around the oil hole 219 and into the space above the chamfer. In the embodiment illustrated, the sleeve alignment feature 208 is integral to the main journal sleeve 214. As illustrated, the sleeve alignment feature 208 may protrude inward from one of the main journal sleeve sections 216 that combine to form the main journal sleeve 214.

Referring to FIG. 5, the rod journal 220 includes a rod journal sleeve 224 and a rod journal integral portion. The rod journal sleeve 224 may include any of the features described herein related to the main journal sleeve 214, the inner journal sleeve 124, the cam sleeve 134, and the end journal sleeve 114. Similarly, the rod journal integral portion may include any of the features described herein related to the main journal integral portion 212, the inner journal integral portion 122, the cam integral portion 132, and the end journal integral portion 112.

The main journals 210 and the rod journals 220 may be joined by webs 230. The main journal integral portions 212 and the rod journal integral portions are integral to the webs 230 and to each other. The mounting flanges 240 may be located at each end of the crankshaft 200.

A shaft for a machine, such as a construction or a mining machine, in accordance with the invention disclosed herein includes at least one contact feature. The contact feature may include the end journal 110, the inner journal 120, the cam 130, the main journal 210, or the rod journal 220. The contact feature includes an integral portion and a sleeve. The integral portion may include any combination of the features described herein relative to the end journal integral portion 112, the inner journal integral portion 122, the cam integral portion 132, and the main journal integral portion 212. The sleeve includes at least one sleeve section and may include multiple sleeve sections. The sleeve may also include any combination of the features described herein relative to the end journal sleeve 114, the inner journal sleeve 124, the cam sleeve 134, and the main journal sleeve 214.

In embodiments, not all contact features include an integral portion and a sleeve. Some contact features of the shaft may only include an integral portion with no sleeve. In other embodiments, all contact features include an integral portion and a sleeve.

The material of the sleeve may be selected based on the desired contact properties at the outer surface of the contact feature, such as the hardness. The sleeve includes materials capable of bonding to the integral portion. In some embodiments, the sleeve includes the same or a similar material as the material of the integral portion. In other embodiments, the sleeve includes materials that are different than the materials of the integral portion. Further, the sleeve may have a surface treatment applied prior to being bonded to the integral portion. The sleeve may include any metal including, inter alia, steel, tool steel, nickel alloys, and bronze.

### INDUSTRIAL APPLICABILITY

Contact features for shafts of machines, such as construction and mining machines, may be subject to various stresses, strains, and various forms of wear. The amount of wear on each contact feature may be based on the location of the contact features, which components of the machine are connecting to or contacting the contact features.

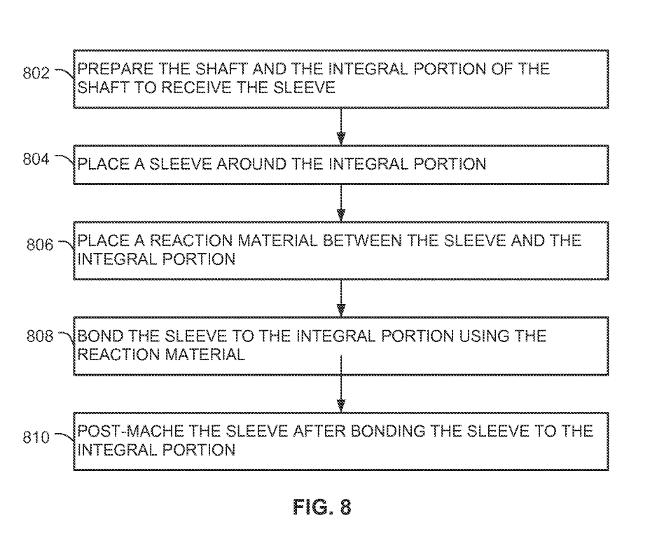

FIG. 8 is a flowchart of a method for manufacturing a rotating shaft including a contact feature for a machine, such as a construction or mining machine. The method may include preparing the shaft and the integral portion of the shaft to receive the sleeve at step 802. Step 802 may include pre-machining, such as grinding, turning, or milling, the integral portion to a predetermined profile. The pre-machining may be performed on a new shaft or on a shaft that is being remanufactured. In some embodiments, the integral portion may be formed with the predetermined profile during the initial manufacturing process of the shaft.

The method includes placing a sleeve around the integral portion at step 804. Step 804 may include aligning the sleeve with the integral portion. In some embodiments, the integral portion and the sleeve include features, such as holes and passages that need to be aligned. Aligning the sleeve with the integral portion may include mating one or more alignment features, such as the integral portion alignment feature 209 and the sleeve alignment feature 208. In some embodiments, aligning the sleeve with the integral portion is performed using an alignment aid to align the features of the sleeve and the integral portion. In embodiments, the alignment aid is an alignment dowel that locates the sleeve relative to the integral portion, such as by placing the alignment dowel in the oil hole and oil passage. The alignment aid may remain during the bonding step and may be removed after the bonding step is completed.

In embodiments, the sleeve is placed around the integral portion with an interference fit. These embodiments may include a sleeve that is formed of a single integral piece.

The method also includes placing a reaction material between the sleeve and the integral portion at step 806. Step 806 may include applying the reaction material to the inner surface of the sleeve or applying the reaction material to the outer surface of the integral portion prior to placing the sleeve around the integral portion. Applying the reaction material to the inner surface of the sleeve or to the outer surface of the integral portion may include coating the surface with a layer of the reaction material. Placing the sleeve around the integral portion may simultaneously place the reaction material between the sleeve and the integral portion when the reaction material has already been applied to either the inner surface of the sleeve or the outer surface of the integral portion.

The method further includes bonding the sleeve to the integral portion using the reaction material at step 808. Step 808 may include bonding at least a majority of an interface between the integral portion and the sleeve together. Step 808 may also include initiating an exothermic reaction in the reaction material. The exothermic reaction may be initiated electrically, thermally, or mechanically. In some embodiments, an electricity source, such as a battery, or an arc welder, provides an electrical charge the supplies the energy to initiate the exothermic reaction. In other embodiments, a heat source, such as a soldering iron, provides the heat that supplies the energy to initiate the exothermic reaction. In yet other embodiments, mechanical energy supplies the energy to initiate the exothermic reaction, such as by striking the material physically.

Once initiated, the exothermic reaction may self-propagate and generate enough heat to bond the sleeve and integral portion together. The exothermic reaction may cause the bond without causing enough heat to significantly affect the properties of the sleeve and the integral portion. Step 808 may bond a majority of the interface between the sleeve and the integral portion together, such as bonding the inner surface of the sleeve to a majority of the outer surface of the integral portion. The bond may be strong enough to withstand the stresses and strain in the journal caused during contact with other components of the machine. The bond may be able to withstand stresses and strains to prevent rotation between the integral portion and the sleeve in situations where an interference fit between a journal and a sleeve may not be sufficient to prevent independent rotation of the sleeve relative to the journal. In some embodiments, the reaction material may include, for example, thermite, a mixed powder of iron oxide and aluminum, or metals that can have an intermetallic reaction, such as nickel and aluminum.

The method may further include post-machining the sleeve after bonding the sleeve to the integral portion at step 810. Step 810 may include machining the sleeve to a desired profile of the journal, the desired profile being within the dimensional requirements of the journal.

In some embodiments, the method includes surface treating, such as heat treating or cold working, the sleeve. The surface treatment may be performed before or after steps 806 and 808. Surface treating, such as heat treating, the sleeve prior to steps 806 and 808 may allow for the modifying of the material properties of the sleeve without affecting the material properties of the remainder of the shaft. This may allow for a shaft that includes multiple journals to have journals with different surface treatments and different properties. Journals with different properties can also be accomplished by using journals of different materials.

In some embodiments, the sleeve includes multiple sleeve sections. The method may include forming a closed loop of the sleeve sections around the integral portion and bonding the sleeve sections together. In some embodiments, bonding the sleeve sections together may include a bonding process that uses an external heat source, such as welding. The welding may initiate the exothermic reaction. In other embodiments, the reaction material is also placed between the adjacent ends of the sleeve sections and the exothermic reaction also bonds the sleeve sections together. The multiple sleeve sections facilitate placing a sleeve around an integral portion that could not otherwise receive a sleeve due to its location on the shaft.

The process illustrated in FIG. 8 is subject to many variations, including adding, omitting, reordering, or altering steps. Additionally, steps or sub-steps may be performed concurrently. For example, applying the reaction material to an inner surface of the sleeve may be performed before, after, or concurrently with preparing the shaft and integral portion to receive the sleeve.

The preceding detailed description is merely exemplary in nature and is not intended to limit the invention or the application and uses of the invention. The described embodiments are not limited to use in conjunction with a particular type of machine. Hence, although the present disclosure, for convenience of explanation, depicts a rotating shaft for a construction or mining machine, it will be appreciated that the rotating shaft in accordance with this disclosure can be implemented in various other configurations and can be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

What is claimed is:

1. A contact feature of a shaft for a machine, the contact feature comprising:
an integral portion that is integral to the shaft, the integral portion including a profile that is less than an overall profile of the contact feature;
a sleeve located around the integral portion, the sleeve including the overall profile of the contact feature; and
a bond layer located between the integral portion and the sleeve, the bond layer joining at least a majority of an interface between the integral portion and the sleeve together.

2. The contact feature of claim 1, wherein the bond layer includes materials from the integral portion and from the sleeve, and includes residual reaction materials from an exothermic reaction.

3. The contact feature of claim 1, wherein the sleeve includes multiple sleeve section bonded together around the integral portion.

4. The contact feature of claim 3, wherein each end of the multiple sleeve sections is not normal to an outer and an inner surface of the sleeve.

5. The contact feature of claim 3, wherein the integral portion includes an integral portion alignment feature and the sleeve includes a sleeve alignment feature protruding inward from one of the multiple sleeve sections, and wherein the sleeve alignment feature is mated to the integral portion alignment feature.

6. The contact feature of claim 1, wherein the integral portion includes an integral portion alignment feature and the sleeve includes a sleeve alignment feature mated to the integral portion alignment feature.

7. The contact feature of claim 1, wherein the contact feature includes a journal and the sleeve includes a cylindrical shape.

8. The contact feature of claim 1, wherein the contact feature includes a cam and the integral portion includes a lobe.

9. A method for manufacturing a shaft for a machine, the method comprising:
placing a sleeve around an integral portion of the shaft;
placing a reaction material between the sleeve and the integral portion; and
bonding an interface between the integral portion and the sleeve together with the reaction material to form a contact feature of the shaft that includes the sleeve, the integral portion and a resultant bond layer there between.

10. The method of claim 9, wherein placing the reaction material between the sleeve and the integral portion includes applying the reaction material to an inner surface of the sleeve prior to placing the sleeve around the integral portion of the shaft.

11. The method of claim 9, wherein bonding the interface between the integral portion and the sleeve includes initiating an exothermic reaction of the reaction material, and wherein the exothermic reaction generates heat to bond the sleeve to the integral portion.

12. The method of claim 9, wherein placing the sleeve around the integral portion includes mating a sleeve alignment feature of the sleeve with an integral portion alignment feature of the integral portion.

13. The method of claim 9, wherein the sleeve includes a plurality of sleeve sections and placing the sleeve around the integral portion includes forming a closed loop with the plurality of sleeve sections around the integral portion, the method further comprising bonding the plurality of sleeve sections together.

14. The method of claim 13, wherein bonding the plurality of sleeve sections together includes applying the reaction material to adjoining ends of the plurality of sleeve sections and forming bonds between the adjoining ends.

15. The method of claim 9, further comprising machining the integral portion to a predetermined profile prior to placing the sleeve around the integral portion.

16. The method of claim 9, further comprising surface treating the sleeve prior to placing the sleeve around the integral portion.

17. A shaft for a machine, comprising:
a first contact feature including
a first integral portion that is integral to the shaft, the first integral portion including a profile that is less than an overall profile of the first contact feature,
a first sleeve located around the first integral portion, the first sleeve including the overall profile of the contact feature, and
a first bond layer located between the first integral portion and the first sleeve, the first bond layer joining a first interface between the first integral portion and the first sleeve together; and
a second contact feature spaced apart from the first contact feature, the second contact feature including a second integral portion that is integral to the shaft.

18. The shaft claim 17, wherein the second contact feature includes:
a second sleeve located around the second integral portion, the second sleeve including the overall profile of the second contact feature, and
a second bond layer located between the second integral portion and the second sleeve, the second bond layer joining a second interface between the second integral portion and the second sleeve together.

19. The shaft claim 17, wherein the first sleeve includes a plurality sleeve sections bonded together around the first integral portion.

20. The shaft claim 17, wherein the first integral portion includes an integral portion alignment feature and the first sleeve includes a sleeve alignment feature protruding inward, and wherein the sleeve alignment feature is mated to the integral portion alignment feature.
